(19) United States
(12) Patent Application Publication
(10) Pub. No.: US 2017/0042126 A1
(43) Pub. Date: Feb. 16, 2017

(54) CHEERING POMPOMS FOR PETS

(71) Applicant: Isaac Opiyo, Omaha, NE (US)

(72) Inventor: Isaac Opiyo, Omaha, NE (US)

(21) Appl. No.: 14/825,266

(22) Filed: Aug. 13, 2015

(51) Int. Cl. A01K 29/00

(52) U.S. Cl. CPC A01K 29/00

(57) ABSTRACT

A pompom wearable on the leg of a dog having an encircling elastic sleeve formed from a flat rectangular elastic member fastened together at its ends. Streamers attached to the elastic member extend downwardly therefrom. Fasteners at each end connect to form a cylindrical structure that encircles one of a dog's legs. Streamers length is chosen so that the pompoms do not impede the dog's ability to walk or run freely. Special attention is paid to make the pompom comfortable for the dog by not interfering with sweat glands in or near the paws. The pompoms are wearable on each leg of the dog movement of the legs causes shake or so called drapery motion of the pompom strands. The elastic member may carry a logo, more theme colors and/or other indicia, for example, an advertisement. Streamers may be attached either permanently or removably.

### FIELD OF THE INVENTION

The invention pertains to decorative attachments for wearing by animals and, more particularly, to cheering pompoms for attachment typically to one or more legs of an animal.

### BACKGROUND OF THE INVENTION

Pets are ubiquitous in society today and are seen in many locations accompanying their owners. Pet owners, especially those with family members engaged in athletic endeavors desire to the watch games or matches in which their family member(s) participate. As used hereinafter the term game is used to refer to any game, match, or other athletic endeavor in which one or more participants compete against one or more participants of an opposing group or team.

A family member, especially a child may have one or more games per week. These multiple games may require leaving a pet, especially a dog or other similar animal at home while the family attends a game. Consequently, families often bring one or more pets to a game.

Games, particularly between rival teams, are often accompanied by cheering, either led by cheerleaders or erupting spontaneously among the fans. Fans typically carry signs, banners or wear clothing bearing their team's colors. Favorite items for cheering their team onward include pompoms in their team's colors. Fans wave their pompoms in response to a pleasing team action such as scoring.

Pet owners have a longstanding tradition of “dressing up” their pets for Halloween, Saint Patrick's Day, and other similar holidays. Their enthusiasm for dressing their pets seems to have extended to athletic events. A simple search of the Internet using a search terms such as “canine cheerleaders” leads a searcher to numerous “hits” where photographs of dogs (as well as cats) dressed in “cheerleading” attire as well as news stories regarding dogs along footrace courses “encouraging” a family along the course can be found.

Fans also may dress their pet(s) in clothing items in similar colors. Pets may well be visible to the team or to other spectators from the sidelines or the stands.

It would, therefore, be advantageous to provide a pompom wearable on the leg of a pet, especially a dog that would not interfere with the dog's ability to walk or run nor interfere with sweat glands in the dog's paws.

### DISCUSSION OF THE RELATED ART

The concept of dressing a pet, especially a dog, in manner to resemble a cheerleader is not new. For example, a stock image “Cheerleader Dog”, readily available from Depositphotos.com shows an image of a forward-facing dog with what appears to be large pompoms surrounding its front paws.

Another readily available image shows three poodles all wearing pompoms and shown in a typical cheerleading formation. The image is ID 1523 available at JohnLund.com.

Another image shows an English bulldog dressed as a cheerleader, including pompoms surrounding the dog's front paws. The image is Item No. 10362103 by Willee Cole and available at Shutterstock.com.

An image titled “Blue Cheerleader” shows a commercially available dog costume, item #885921 from Rubie's Costume Company accessible at Rubies.com.

U.S. Pat. No. 4,369,215 for FINGER HELD POMPOM issued Jan. 18, 1983 to Matt D. Offen et al. provides a pompon having a plastic body member that has strands attached to an end thereof, and wherein a clip is provided for holding the strands in place on the member. One end of the holder or member is open so that a coupon or the like can be conveniently inserted within the member. Suitable advertisements, logos, and the like can be imprinted on the outer surface of the finger held pompom. The finger held pompon includes a receptacle that is constructed of plastic material of resilient characteristics whereby the user's finger can be conveniently inserted within the device to provide a convenient means of manipulating the pompon.

U.S. Pat. No. 5,234,725 for WRIST POMPON (sic) STRUCTURE issued Aug. 10, 1993 to Catherine L. Smith teaches a wrist pom that may be utilized by individuals in cheerleading and the like. The wrist pompom includes an elastomeric sleeve having a forward annular end receiving a collar therewithin wherein the collar has fixedly secured thereto an annular array of elongated, flexible tassel webs at rear distal ends of each web.

U.S. Pat. No. 7,654,682 for GLOVE-SUPPORTING A POM POM AT A FINGER TIP, issued Feb. 2, 2010 to Teressa E. Denham discloses a glove having a pompom freely attached to a tip of one or more of the glove fingers. The glove may bear indicia, for example, a team logo. The pompoms are typically multicolored, consisting of strands of the team, school, or organization colors. The gloves provide warmth to the wearer's hands. In addition, the wearer's hands are free to hold other items, for example, beverage containers, cameras, programs, etc. Selective movement of a wearer's fingers and/or thumb causes a respective pompom to move in response thereto. Patterns of successive finger/thumb movements may be executed to cause a variety of visual effects from the pompom-bearing glove. Bells and/or light sources may also be attached to the gloves instead of or in addition to the pompoms. A motion sensitive switch and/or a simple sequencer may be used to create predetermined or random light patterns.

None of the patents and or images, taken singly, or in any combination are seen to teach or suggest the novel cheering pompoms for pets of the present invention.

### SUMMARY OF THE INVENTION

In accordance with the present invention there is provided a pompom wearable on the lower leg of a pet, particularly a dog. The novel pompom uses a specially constructed elastic sleeve formed from a flat rectangular, two-layer elastic member having a left end, a right end, an upper edge, and a lower edge. Elongated streamers are attached to the elastic member along the lower edge. Elongated streamers may be permanently or removably attached to the elastic member.

A fastening system disposed near least one of the right and left ends serves to secure the right end to the left end thereby forming a cylindrical structure that encircles one of a dog's lower legs. In an alternate embodiment, the pompom may be supplied in a permanently formed cylindrical structure.

The length of the streamers is chosen such that the pompoms formed therefrom do not impede the dog's ability walk or run freely while wearing one or more of the novel pompoms. Special attention is made in the pompom design to make the pompom comfortable for the dog by not interfering with sweat glands at the paws of some canine species. The pompoms are wearable on each leg of the dog and are constructed in a manner that when the dog walks or runs, the movement of the legs causes shake or so called drapery motion of the pompom strands. The elastic member is typically constructed with sufficient distance top-to-bottom to provide a large enough surface area to carry a logo, more theme colors and/or other indicia, for example, an advertisement.

In yet other embodiments, decorative jewelry may be permanently or removably attached to the elastic member.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front elevational, schematic view of a pompom in accordance with the invention in a flat, unfastened, upstretched configuration;

FIG. 2 is a rear elevational, schematic view of the pompom of FIG. 1;

FIG. 3 is a front elevational, schematic view of the pompom of FIG. 1 shown in a partially stretched configuration;

FIG. 4 is a front perspective view of the pompom of FIG. 1 partially reconfigured from a flat configuration to a cylindrical configuration;

FIG. 5 is a front perspective, schematic view of a dog wearing a completely cylindrically configured pompom in accordance with the invention on each of its front legs;

FIG. 6 is a front elevational, schematic view of an alternate embodiment wherein streamers are attached to the elastic member with a hook-and-loop fastening system;

FIG. 7 is another alternate embodiment of the pompom in accordance with the invention configure permanently in a cylindrical configuration;

FIG. 8 is a front elevational, schematic view of an embodiment wherein a fastening system is a hook-and-loop material;

FIG. 9 is a rear elevational, schematic view of the pompom of FIG. 8; and

FIG. 10 is a front elevational, schematic view of an alternate embodiment of the pompom having jewelry selectably attachable to a seam of a pompom.

### DETAILED DESCRIPTION OF THE PREFERRED EMBODIMENT

The present invention provides pompoms wearable on one or more legs of a pet, particularly an animal such as a dog. For simplicity, the term dog is used hereinafter to refer to any animal having a leg structure adapted to support the novel pompom of the invention. Consequently, the invention is not considered limited to dogs used for purposes of disclosure. Rather, the invention is intended to include any other animal having a leg structure that can support the pompom structure of the present invention.

Unlike prior art attempts to provide pompoms that are attachable to the leg of a dog, the pompom of the invention does not use a thin rubber band or the like to attach streamers to the leg of a dog. A thin rubber band applies a concentrated pressure to the dog's leg that can be uncomfortable or possibly injurious to the dog.

Also, unlike other prior art devices, the pompom of the invention does not attach streamers to a dog's leg by attaching streamers to a stick and then typing the stick to the dog's leg. The stick can prevent the dog from bending its leg and certainly can interfere with walking and running.

The present invention uses a relatively wide elastic member with streamers attached along a lower edge that may be fastened around the dog's leg.

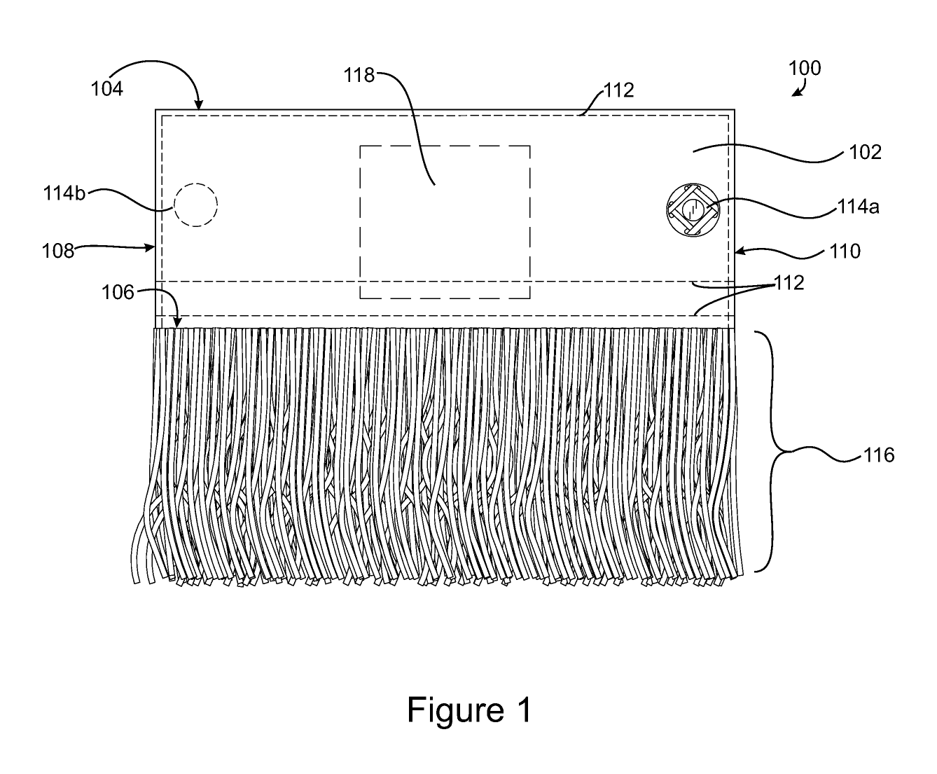

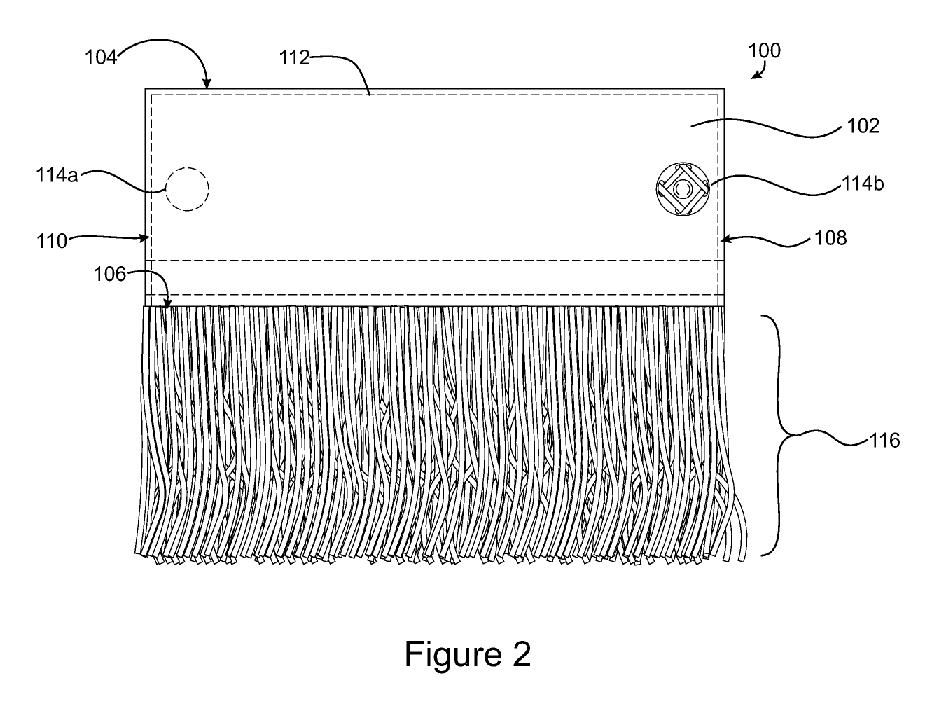

Referring first to FIGS. 1 and 2, there are shown front and rear elevational, schematic views, respectively, of a pompom structure in accordance with the invention, generally at reference number 100.

A rectangular elastic member 102 has an upper edge 104, a lower edge 106, a left end 108 and a right end 110. Elastic member 102 may be a solid color or, in alternate embodiments, may consist of alternate colors in a geometric or random pattern. Typically, rectangular elastic member is formed from a double layer of elastic material stitched one to the other by stitching 112.

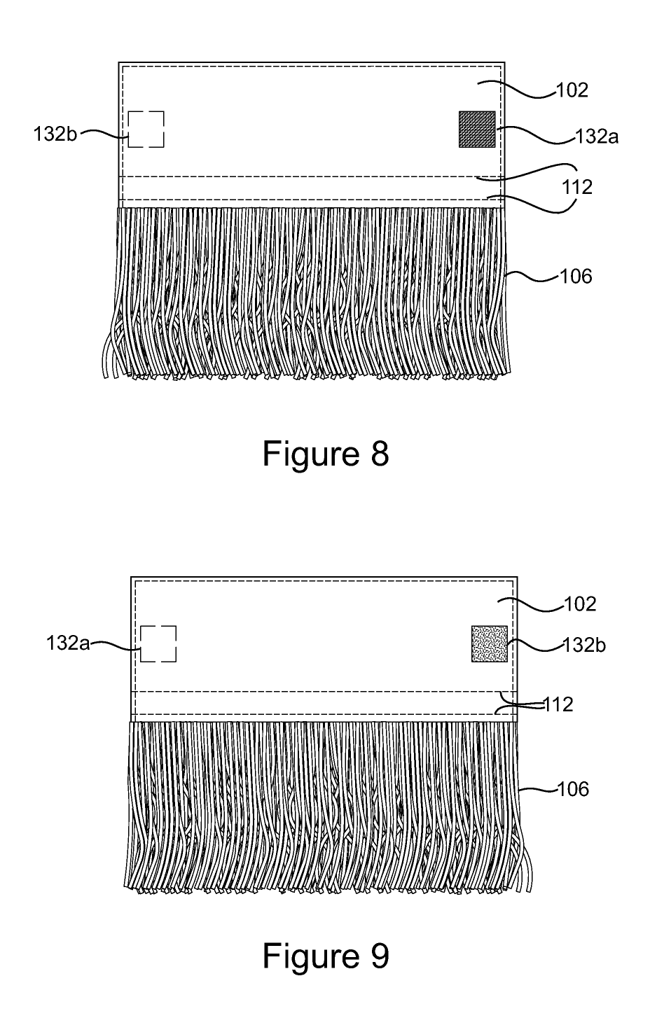

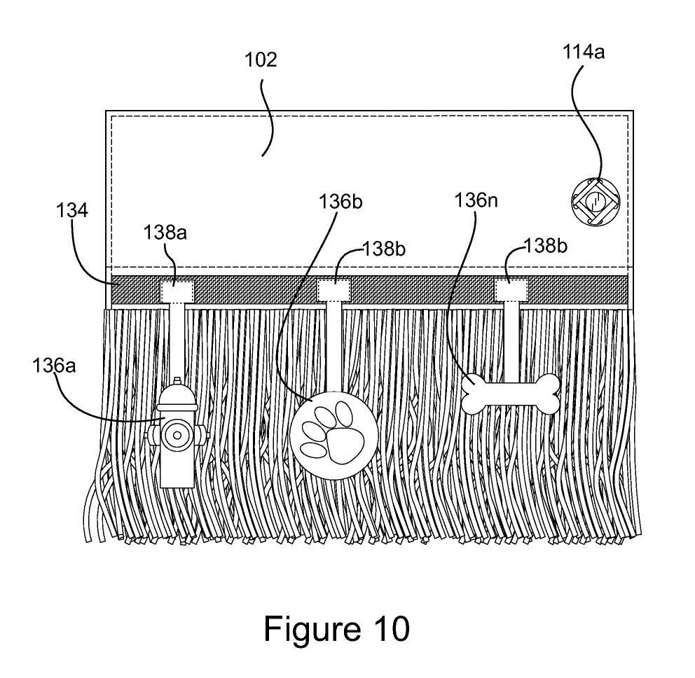

Fastener components 114a, 114b form a fastening system designed and configured to selectively secure left edge 108 to right edge 110. While fastening system 114a, 114b are shown as snaps, it will be recognized by those of skill in the art that many other devices and/or methods may be used to secure left end 108 to right end 110. One other method of implementing a fastening system uses a hook-and-loop material as shown in FIGS. 8 and 9. Consequently, the invention is not limited to the snaps show for purposes of disclosure. Rather, the invention is intended to include any and all suitable other fastening systems. Such other fastening systems include, but are not limited to, buttons, zippers, hook-and-loop fasteners, hooks and eyes, etc. Further, while a single fastener component 114a, 114b are shown proximate respective left and right edges, it will be recognized that additional fastener components may be added in-line with one or both fastener components 114a, 114b along the major axis of rectangular elastic member to allow size adjustability of pompom 100.

It will be recognized that rectangular elastic member 102 may be provided permanently formed into cylindrical structures as shown in FIG. 7. A stitched, glued, or otherwise permanently fastens edges of rectangular elastic member 102 at seam 130. The elasticity of the materials from which rectangular elastic member 102 is formed should be selected such that the permanently formed cylindrical structure has the necessary elasticity to slip over the paw of a dog while staying positioned on the dog's leg once in place. All other structural details discussed hereinbelow are applicable to the permanently formed cylindrical structure.

A plurality of streamers 116 are attached along lower edge 106 of elastic member 102. Typically streamers 116 are captured between the two layers of rectangular elastic member 102 and held in place by stitching 112.

Streamers 116 are typically braided threads having very high flexibility. In alternate embodiments, streamers 116 may be formed from thin, rectangular elongated, polymeric strands having cross-section selected from the group: a circle, an oval, a square, a rectangle, a regular polygon, and an irregular polygon. Streamers could alternately be formed from paper or other similar material.

Streamers 116 are typically solid colors. All streamers 116 may be a single color or groups of streamers selected from the plurality of streamers 116 may be of different solid or variegated colors.

As the pompoms of the invention may be used for “cheering” purposes, the color of elastic member 102 and of streamers 116 are typically selected to match the colors of the team or group being cheered for.

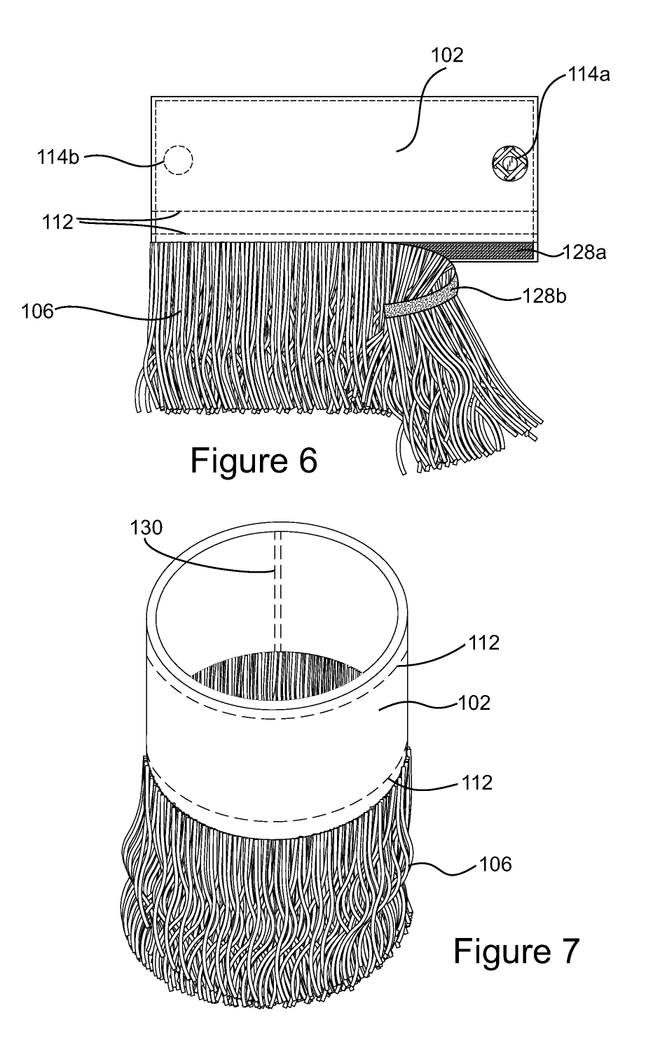

In alternate embodiments, streamers 116 may be removably attached at or near a lower edge 106 of elastic member 102. As may be seen in FIG. 6, streamers 106 are attached to rectangular elastic member 102 by a hook-and-loop fastening system 128a, 128b. Other suitable methods or devices fir removable attaching streamers 106 are believed to be well known to those of skill in the art. This feature allows different colored streamers 116 to be worn for different occasions. For example, the color of streamers 116 may be chosen to coordinate with the clothing being worn by the pet owner and changed when the pet owner wears a different outfit.

A region 118 illustrates a possible location of a logo, an advertisement, or other indicia. In alternate embodiments, region 118 could contain colored patterns that augment the colors chosen for elastic member 102 and/or streamers 116.

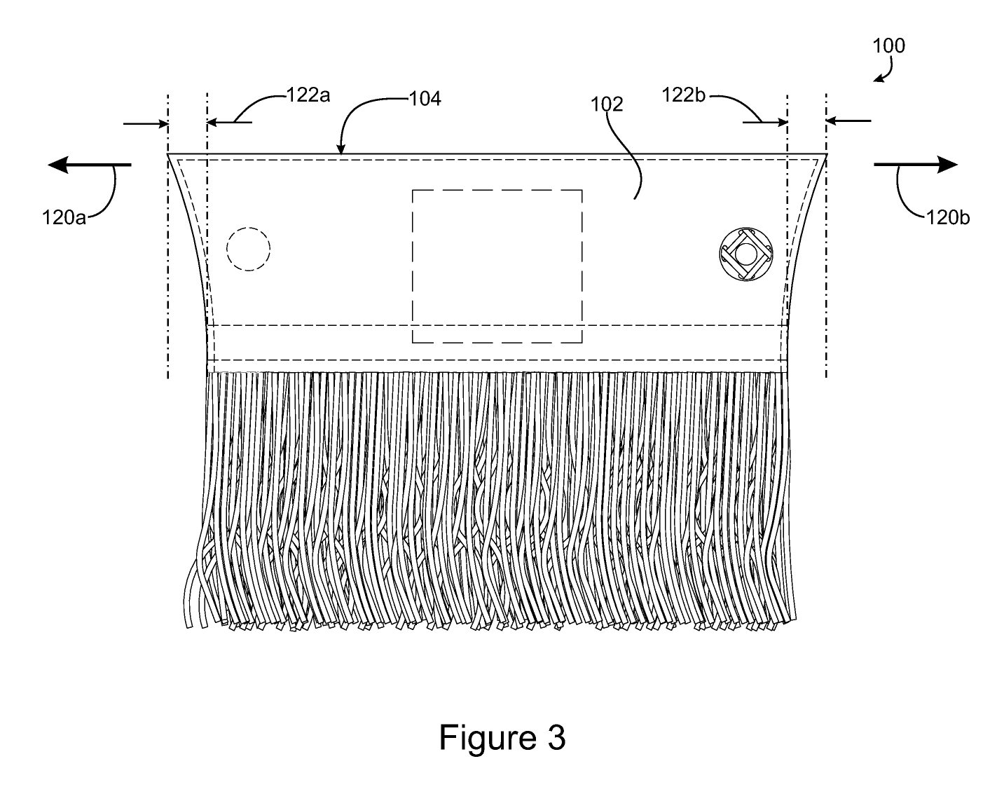

Referring now also to FIG. 3, there is shown a front elevational, schematic view of the pompom of FIG. 1 and showing the upper region of rectangular elastic member 102 being stretched in a direction parallel to upper edge 104.

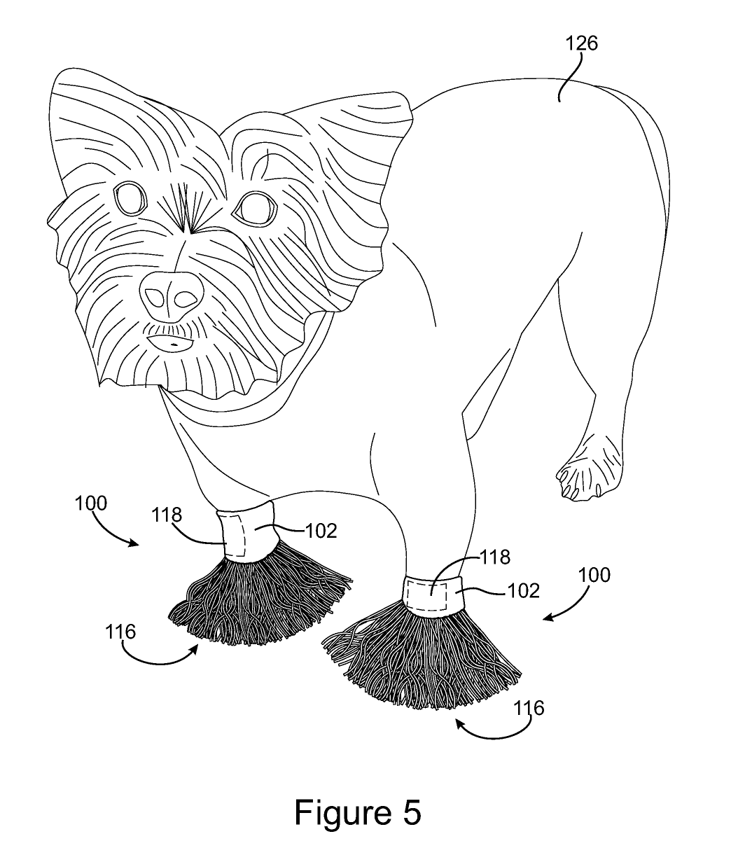

The elasticity of rectangular elastic member 102 is chosen to retain pompom 100 in place comfortably on the leg, not shown in FIG. 3, of a dog while not exerting undo pressure on the dog's leg. Pompom 100 in place on a dog's let is best seen in FIG. 5.

Opposing outward force components represented by arrows 120a, 120b is shown applied to respective left edge 108 and right edge 110 proximate upper edge 104 of rectangular elastic member 102. When opposing force components 120a, 120b are applied as shown, the respective right edge 108 and left edge stretch outwardly as shown by respective distances 122a, 122b. It will be recognized that the actual elongated shape of rectangular elastic member 102 will depend upon where along left edge 108 and right edge 110 respective force components 120a, 120b are applied. The elastic character of rectangular elastic member 102 allows it to conform to the contour of the dog's leg when formed into the cylindrical pompom.

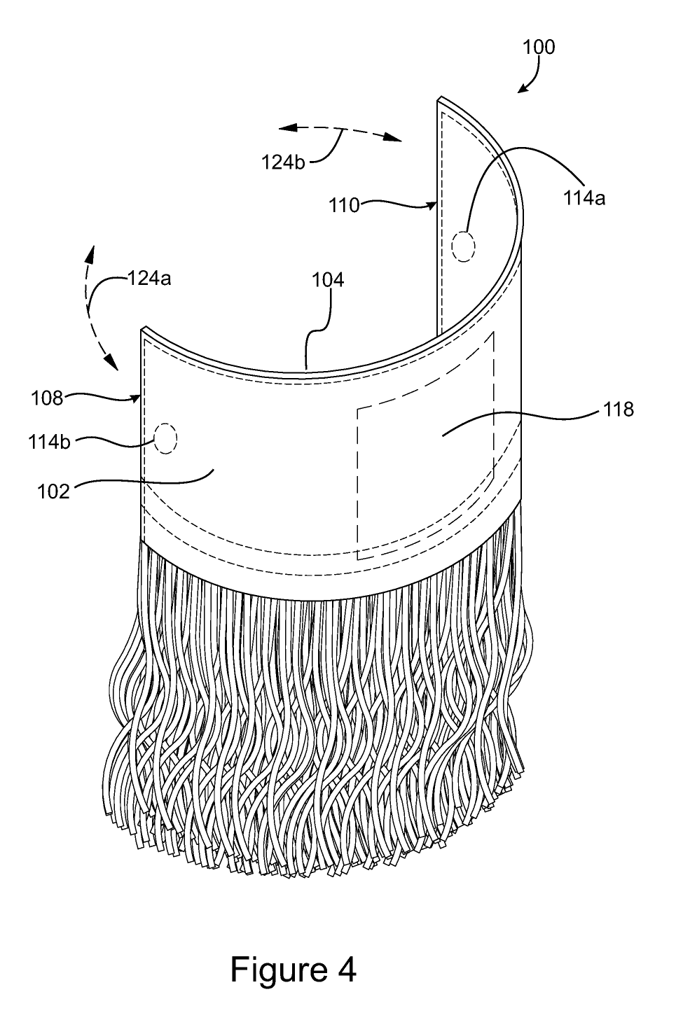

Referring now also to FIG. 4, there is shown a perspective, schematic view of pompom 100 partially formed into a cylinder in anticipation of placing pompom 100 around a dog's leg, best seen in FIG. 5.

Right edge 108 of rectangular elastic member 102 is moved toward left edge 110 as shown by arrows 124a, 124b.

Referring now also to FIG. 5, there is shown a front perspective, schematic view of a dog 126 having a pompom 100 on both right and left front legs, not specifically identified. Dog 126 forms no part of the present invention and is shown only to illustrate the intended operating environment for pompoms 100.

Referring now also to FIG. 10, there is shown a front elevational, schematic view of another alternate feature of the cheering pom poms for pets in accordance with the invention. In this embodiment, individual decorative items (e.g., jewelry) may be removably attached to rectangular member 102. In the arrangement chosen for purposes of disclosure, a fire hydrant 136a, a paw print 136b, and a dog bone 136n are attached to rectangular elastic member using a strip of hook-and-loop material 134a. It will be recognized that mating hook-and-loop material 134b may be attached to attachment regions 138a, 138b. . . 138n.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A pompom adapted to be worn by a dog or similar animal, comprising:
a) a substantially rectangular, elastic member having an upper edge, a lower edge, a left edge, and a right edge.
b) a two-part fastening system having a first portion disposed on said elastic member proximate said left end and a mating second portion disposed proximate said right end of said elastic member;
c) a plurality of streamers attached to said elastic member proximate said lower edge and extending outwardly therefrom, said plurality of streamers being distributed along a full width of said elastic member.

2. The pompom adapted to be worn by a dog or similar animal as recited in claim 1, wherein said rectangular, elastic member comprises at least a two-layer rectangular elastic member.

3. The pompom adapted to be worn by a dog or similar animal as recited in claim 2, wherein said two layers are adhered one to the other by stitching disposed through both of said two layers.

4. The pompom adapted to be worn by a dog or similar animal as recited in claim 1, wherein said two-part fastening system comprises at least one selected from the group: a two-part snap, at least one button and mating button hole, a zipper, a hook-and-loop fastener system, and at least one hook and mating eye.

5. The pompom adapted to be worn by a dog or similar animal as recited in claim 1, wherein said streamers comprise at least one selected from the group comprising: a plurality of braided threads, a plurality of polymeric streamers, each having a cross-section selected from the group: a circle, an oval, a square, a rectangle, a regular polygon, and an irregular polygon.

6. The pompom adapted to be worn by a dog or similar animal as recited in claim 5, wherein all of said plurality of streamers is a single color.

7. The pompom adapted to be worn by a dog or similar animal as recited in claim 5, wherein at least one of said plurality of streamers is a color different than the color of at least one other of said plurality of streamers.

8. The pompom adapted to be worn by a dog or similar animal as recited in claim 3, further comprising:
d) indicia placed on an outfacing surface of at least one of said two layers.

9. The pompom adapted to be worn by a dog or similar animal as recited in claim 8, wherein said two-part fastening system comprises at least one selected from the group: a two-part snap, at least one button and mating button hole, a zipper, a hook-and-loop fastener system, and at least one hook and mating eye.

10. The pompom adapted to be worn by a dog or similar animal as recited in claim 8, wherein said streamers comprise at least one selected from the group comprising: a plurality of braided threads, a plurality of polymeric streamers, each having a cross-section selected from the group: a circle, an oval, a square, a rectangle, a regular polygon, and an irregular polygon.

11. The pompom adapted to be worn by a dog or similar animal as recited in claim 10, wherein all of said plurality of streamers is a single color.

12. The pompom adapted to be worn by a dog or similar animal as recited in claim 8, wherein at least one of said plurality of streamers is a color different than the color of at least one other of said plurality of streamers.

13. The pompom adapted to be worn by a dog or similar animal as recited in claim 1, wherein said left edge, and said right edge of said substantially rectangular, elastic member are permanently fastened to one another.

14. The pompom adapted to be worn by a dog or similar animal as recited in claim 3, wherein said a plurality of streamers are fastened to said elastic member using one of the modalities selected from the group: permanently, and removably.
